(19) United States
(12) Patent Application Publication
(10) Pub. No.: US 2020/0004559 A1
(43) Pub. Date: Jan. 2, 2020

(54) Method for Performing Configuration for External Device, and Device

(71) Applicant: Huawei Technologies Co., Ltd., Shenzhen, Guangdong (CN)

(72) Inventors: Qingfeng Cao, Shenzhen (CN); Siqi Hao, Helsinki (FI); Xutao Gao, Xi'an (CN); Quan Yuan, Xi'an (CN)

(21) Appl. No.: 16/489,259

(22) PCT Filed: Jun. 8, 2017
(86) PCT No.: PCT/CN2017/087626

§ 371 Date: Aug. 27, 2019

(30) Foreign Application Priority Data
Feb. 27, 2017 (CN) 201710109484.7

(51) Int. Cl. G06F 9/445

(52) U.S. Cl. CPC G06F 9/44505; G06F 9/44584; G06F 9/44536; G06F 9/44521

(57) ABSTRACT

A system and device for performing configuration for an external device is provided whereby, when detecting that a terminal device is successfully connected to an external device, the terminal device obtains a differentiated resource package of the external device from a target device. The differentiated resource package of the external device is preconfigured on the target device, and includes a differentiated service and adapted code and a presentation resource that are corresponding to the differentiated service, and the differentiated service is a specific service supported by the external device, and the terminal device configures the differentiated service for the external device based on the adapted code and the presentation resource that correspond to the differentiated service.

This application claims priority to Chinese Patent Application No. 201710109484.7, filed with the Chinese Patent Office on Feb. 27, 2017, and entitled “METHOD FOR PERFORMING DYNAMIC CONFIGURATION FOR EXTERNAL DEVICE, DEVICE, AND SYSTEM”, which is incorporated herein by reference in its entirety. For mere brief description, the original text is not repeated herein in its entirety.

### TECHNICAL FIELD

Embodiments of this application relate to the communications field, and in particular, to a method for performing configuration for an external device, and a device.

### BACKGROUND

With rapid development of electronic technologies, more types of external devices can be connected to a terminal device, and some external devices can support increasingly rich service functions. For example, external devices that currently can be connected to a mobile phone include wearable devices such as a Bluetooth headset and a smartwatch. The smartwatch can support, in synchronization with the mobile phone, services functions such as call making, short message sending/receiving, sleep monitoring, heart rate monitoring, sedentariness reminding, running recording, remote photographing, music playing, video recording, and a compass. Generally, configuration for the external device mainly depends on the terminal device.

In the prior art, to enable the terminal device to perform different configurations based on different types of external devices, both adapted code required for configuring different service functions for different types of external devices and resources required for performing presentation processing at a service layer are usually prestored in the terminal device. In this way, after an external device is connected to the terminal device, the terminal device can perform configuration for the external device based on a type of the external device by using prestored corresponding adapted code and a prestored corresponding resource required for performing presentation processing at the service layer.

However, with an increase in types of external devices and richness of supported service functions, the terminal device needs to store a large volume of adapted code and a large quantity of resources required for performing presentation at the service layer. Only in this way, the terminal device can implement configuration for different types of external devices. Consequently, resource overheads of the terminal device are extremely high. In addition, the solution in the prior art further requires that a version of an application (Application, APP) that is in the terminal device and that is configured to perform configuration for an external device needs to match a version of the external device. Consequently, management and development costs are relatively high.

### SUMMARY

Embodiments of this application provide a method for performing configuration for an external device, and a device, to resolve a problem that extremely high resource overheads of a terminal device and relatively high management and development costs are caused to perform different configurations for different types of external devices.

To resolve the foregoing technical problem, the embodiments of this application provide the following technical solutions.

A first aspect of the embodiments of this application provides a method for performing configuration for an external device, including:

when detecting that a terminal device is successfully connected to an external device, obtaining, by the terminal device, a differentiated resource package of the external device from a target device, where the differentiated resource package of the external device is preconfigured on the target device, the differentiated resource package includes a differentiated service and adapted code and a presentation resource that are corresponding to the differentiated service, and the differentiated service is a specific service supported by the external device; and configuring, by the terminal device, the differentiated service for the external device based on the adapted code and the presentation resource that are corresponding to the differentiated service.

In the method for performing configuration for an external device that is provided in this embodiment of this application, when detecting that the terminal device is successfully connected to the external device, the terminal device obtains the differentiated resource package of the external device from the target device in which the differentiated resource package of the external device is preconfigured, and configures the differentiated service for the external device based on the adapted code and the presentation resource that are included in the obtained differentiated resource package and that are corresponding to the differentiated service. The differentiated resource package of the external device is preconfigured on the target device rather than the terminal device, and when detecting that the terminal device is successfully connected to the external device, the terminal device obtains the differentiated resource package of the external device from the target device, to complete configuration for the external device based on the obtained differentiated resource package of the external device. Therefore, resource overheads of the terminal device and management and development costs are reduced while different configurations are performed for different types of external devices.

With reference to the first aspect, in a possible implementation, the target device is the external device; before the obtaining a differentiated resource package of the external device from a target device, the method for performing configuration for an external device may further include: querying, by the terminal device, whether the external device has a dynamic resource loading capability; obtaining, by the terminal device, version information of the differentiated resource package if the external device has the dynamic resource loading capability, and determining, by the terminal device based on the version information of the differentiated resource package, whether the terminal device has a compatibility capability to load the differentiated resource package, and whether the terminal device needs to load the differentiated resource package: and correspondingly, the obtaining a differentiated resource package of the external device from a target device may specifically include: obtaining, by the terminal device, the differentiated resource package from the external device if the terminal device has the compatibility capability to load the differentiated resource package and needs to load the differentiated resource package.

With reference to the first aspect and the foregoing possible implementation, in another possible implementation, the method for performing configuration for an external device may further include: displaying, by the terminal device, prompt information if the external device has no dynamic resource loading capability, or the terminal device has no compatibility capability to load the differentiated resource package, or the terminal device determines that the terminal device does not need to load the differentiated resource package.

With reference to the first aspect and the foregoing possible implementations, in another possible implementation, the obtaining, by the terminal device, version information of the differentiated resource package may specifically include: calling, by the terminal device, a first application programming interface (Application Programming Interface, API), where the first API is configured to request the version information of the differentiated resource package from the external device; and receiving, by the terminal device, the version information of the differentiated resource package from the external device.

With reference to the first aspect and the foregoing possible implementations, in another possible implementation, the obtaining, by the terminal device, the differentiated resource package from the external device may specifically include: calling, by the terminal device, a second API, where the second API is configured to request the differentiated resource package from the external device; and receiving, by the terminal device, the differentiated resource package from the external device.

With reference to the first aspect and the foregoing possible implementations, in another possible implementation, the target device is a server; before the obtaining a differentiated resource package of the external device from a target device, the method for performing configuration for an external device may further include: querying, by the terminal device, whether the external device has a dynamic resource loading capability; obtaining, by the terminal device, hardware version information and software version information of the external device if the external device has the dynamic resource loading capability: and determining, by the terminal device based on the hardware version information and the software version information, whether the terminal device has a compatibility capability to load the differentiated resource package, and whether the terminal device needs to load the differentiated resource package: and correspondingly, the obtaining a differentiated resource package of the external device from a target device may specifically include: obtaining, by the terminal device, the differentiated resource package from the server based on the hardware version information and the software version information if the terminal device has the compatibility capability to load the differentiated resource package and needs to load the differentiated resource package.

With reference to the first aspect and the foregoing possible implementations, in another possible implementation, the method for performing configuration for an external device may further include: displaying, by the terminal device, prompt information if the external device has no dynamic resource loading capability, or the terminal device has no compatibility capability to load the differentiated resource package, or the terminal device determines that the terminal device does not need to load the differentiated resource package.

With reference to the first aspect and the foregoing possible implementations, in another possible implementation, the obtaining, by the terminal device, hardware version information and software version information of the external device may specifically include: calling, by the terminal device, a third API, where the third API is configured to request the hardware version information and the software version information from the external device; and receiving, by the terminal device, the hardware version information and the software version information from the external device.

With reference to the first aspect and the foregoing possible implementations, in another possible implementation, the obtaining, by the terminal device, the differentiated resource package from the server based on the hardware version information and the software version information may specifically include: calling, by the terminal device, a fourth API, where the fourth API is configured to: upload the hardware version information and the software version information to the server, and request the server to return the differentiated resource package: and receiving, by the terminal device, the differentiated resource package from the server.

With reference to the first aspect and the foregoing possible implementations, in another possible implementation, the configuring, by the terminal device, the differentiated service for the external device based on the adapted code and the presentation resource that are corresponding to the differentiated service may specifically include: calling, by the terminal device, a fifth API, where the fifth API is configured to read a first script file; loading, by the terminal device, the first script file to complete preprocessing before loading the differentiated resource package; calling, by the terminal device, a sixth API, where the sixth API is configured to read a second script file; and loading, by the terminal device, the second script file to load the adapted code and the presentation resource that are corresponding to the differentiated service, to complete configuration for the external device.

A second aspect of the embodiments of this application provides a method for performing configuration for an external device, including:

sending, by a target device, a differentiated resource package of an external device to a terminal device, where the differentiated resource package of the external device is preconfigured on the target device, the differentiated resource package includes a differentiated service and adapted code and a presentation resource that are corresponding to the differentiated service, the adapted code and the presentation resource are used by the terminal device to configure the differentiated service for the external device, and the differentiated service is a specific service supported by the external device.

In the method for performing configuration for an external device external device that is provided in this embodiment of this application, the differentiated resource package of the external device is preconfigured on the target device rather than the terminal device, and when detecting that the terminal device is successfully connected to the external device, the terminal device obtains the differentiated resource package of the external device from the target device, to complete configuration for the external device based on the obtained differentiated resource package of the external device. Therefore, resource overheads of the terminal device and management and development costs are reduced while different configurations are performed for different types of external devices.

With reference to the second aspect, in a possible implementation, the target device is the external device; and before the sending, by a target device, a differentiated resource package of an external device to a terminal device, the method for performing configuration for an external device may further include: receiving, by the target device, a first request message from the terminal device, where the first request message is used to request version information of the differentiated resource package from the external device; and sending, by the target device, the version information of the differentiated resource package to the terminal device.

With reference to the second aspect and the foregoing possible implementation, in another possible implementation, before the sending, by a target device, a differentiated resource package of an external device to a terminal device, the method for performing configuration for an external device may further include: receiving, by the target device, a second request message from the terminal device, where the second request message is used to request the differentiated resource package from the external device.

With reference to the second aspect and the foregoing possible implementations, in another possible implementation, the target device is a server; before the sending, by a target device, a differentiated resource package of an external device to a terminal device, the method for performing configuration for an external device may further include: receiving, by the target device, hardware version information and software version information of the external device and a third request message from the terminal device, where the third request message is used to request the server to return the differentiated resource package; and correspondingly, the sending, by a target device, a differentiated resource package of an external device to a terminal device may specifically include: sending, by the target device, the differentiated resource package to the terminal device based on the hardware version information and the software version information.

A third aspect of the embodiments of this application provides a terminal device, including a processor, a communications interface, and a communications bus, where the processor and the communications interface are connected by using the communications bus; the communications interface is configured to: when it is detected that the terminal device is successfully connected to an external device, obtain a differentiated resource package of the external device from a target device, where the differentiated resource package of the external device is preconfigured on the target device, the differentiated resource package includes a differentiated service and adapted code and a presentation resource that are corresponding to the differentiated service, and the differentiated service is a specific service supported by the external device; and the processor is configured to configure the differentiated service for the external device based on the adapted code and the presentation resource that are obtained by the communications interface and that are corresponding to the differentiated service.

With reference to the third aspect, in a possible implementation, the target device is the external device; the processor is further configured to query whether the external device has a dynamic resource loading capability; the communications interface is further configured to obtain version information of the differentiated resource package if the processor determines, through querying, that the external device has the dynamic resource loading capability; the processor is further configured to determine, based on the version information that is of the differentiated resource package and that is obtained by the communications interface, whether the terminal device has a compatibility capability to load the differentiated resource package, and whether the terminal device needs to load the differentiated resource package; and the processor is specifically configured to obtain the differentiated resource package from the external device if the terminal device has the compatibility capability to load the differentiated resource package and needs to load the differentiated resource package.

With reference to the third aspect and the foregoing possible implementation, in another possible implementation, the terminal device further includes a display, configured to display prompt information if the external device has no dynamic resource loading capability, or the terminal device has no compatibility capability to load the differentiated resource package, or the terminal device determines that the terminal device does not need to load the differentiated resource package.

With reference to the third aspect and the foregoing possible implementations, in another possible implementation, the processor is further configured to call a first API, where the first API is configured to request the version information of the differentiated resource package from the external device; and the communications interface is specifically configured to receive the version information of the differentiated resource package from the external device.

With reference to the third aspect and the foregoing possible implementations, in another possible implementation, the processor is further configured to call a second API, where the second API is configured to request the differentiated resource package from the external device; and the communications interface is specifically configured to receive the differentiated resource package from the external device.

With reference to the third aspect and the foregoing possible implementations, in another possible implementation, the target device is a server; the processor is further configured to query whether the external device has a dynamic resource loading capability: the communications interface is further configured to obtain hardware version information and software version information of the external device if the processor determines, through querying, that the external device has the dynamic resource loading capability; the processor is further configured to determine, based on the hardware version information and the software version information that are obtained by the communications interface, whether the terminal device has a compatibility capability to load the differentiated resource package, and whether the terminal device needs to load the differentiated resource package; and the processor is specifically configured to obtain the differentiated resource package from the server based on the hardware version information and the software version information if the terminal device has the compatibility capability to load the differentiated resource package and needs to load the differentiated resource package.

With reference to the third aspect and the foregoing possible implementations, in another possible implementation, the terminal device further includes a display, configured to display prompt information if the external device has no dynamic resource loading capability, or the terminal device has no compatibility capability to load the differentiated resource package, or the terminal device determines that the terminal device does not need to load the differentiated resource package.

With reference to the third aspect and the foregoing possible implementations, in another possible implementation, the processor is further configured to call a third API, where the third API is configured to request the hardware version information and the software version information from the external device; and the communications interface is specifically configured to receive the hardware version information and the software version information from the external device.

With reference to the third aspect and the foregoing possible implementations, in another possible implementation, the processor is further configured to call a fourth API, where the fourth API is configured to: upload the hardware version information and the software version information to the server, and request the server to return the differentiated resource package; and the communications interface is specifically configured to receive the differentiated resource package from the server.

With reference to the third aspect and the foregoing possible implementations, in another possible implementation, the processor is specifically configured to: call a fifth API, where the fifth API is configured to read a first script file; load the first script file to complete preprocessing before loading the differentiated resource package; call a sixth API, where the sixth API is configured to read a second script file; and load the second script file to load the adapted code and the presentation resource that are corresponding to the differentiated service, to complete configuration for the external device.

A fourth aspect of the embodiments of this application provides a target device, including a communications interface, a memory, and a communications bus, where the communications interface and the memory are connected by using the communications bus; the memory is configured to store a differentiated resource package of an external device; and the communications interface is configured to send the differentiated resource package of the external device to a terminal device, where the differentiated resource package includes a differentiated service and adapted code and a presentation resource that are corresponding to the differentiated service, the adapted code and the presentation resource are used by the terminal device to configure the differentiated service for the external device, and the differentiated service is a specific service supported by the external device.

With reference to the fourth aspect, in a possible implementation, the target device is the external device; and the communications interface is further configured to: receive a first request message from the terminal device, where the first request message is used to request version information of the differentiated resource package from the external device; and send the version information of the differentiated resource package to the terminal device.

With reference to the fourth aspect and the foregoing possible implementation, in another possible implementation, the communications interface is further configured to receive a second request message from the terminal device, where the second request message is used to request the differentiated resource package from the external device.

With reference to the fourth aspect and the foregoing possible implementations, in another possible implementation, the target device is a server; the communications interface is further configured to receive hardware version information and software version information of the external device and a third request message from the terminal device, where the third request message is used to request the server to return the differentiated resource package; and the communications interface is specifically configured to send the differentiated resource package to the terminal device based on the hardware version information and the software version information.

A fifth aspect of the embodiments of this application provides a terminal device, including an obtaining unit and a configuration unit, where the obtaining unit is configured to: when it is detected that the terminal device is successfully connected to an external device, obtain a differentiated resource package of the external device from a target device, where the differentiated resource package of the external device is preconfigured on the target device, the differentiated resource package includes a differentiated service and adapted code and a presentation resource that are corresponding to the differentiated service, and the differentiated service is a specific service supported by the external device; and the configuration unit is configured to configure the differentiated service for the external device based on the adapted code and the presentation resource that are obtained by the obtaining unit and that are corresponding to the differentiated service.

With reference to the fifth aspect, in a possible implementation, the target device is the external device; the terminal device may further include a querying unit and a determining unit; the querying unit is configured to query whether the external device has a dynamic resource loading capability; the obtaining unit is further configured to obtain version information of the differentiated resource package if the querying unit determines, through querying, that the external device has the dynamic resource loading capability: the determining unit is configured to determine, based on the version information that is of the differentiated resource package and that is obtained by the obtaining unit, whether the terminal device has a compatibility capability to load the differentiated resource package, and whether the terminal device needs to load the differentiated resource package; and the obtaining unit is specifically configured to obtain the differentiated resource package from the external device if the determining unit determines that the terminal device has the compatibility capability to load the differentiated resource package and needs to load the differentiated resource package.

With reference to the fifth aspect and the foregoing possible implementation, in another possible implementation, the obtaining unit is specifically configured to: call a first API, where the first API is configured to request the version information of the differentiated resource package from the external device; and receive the version information of the differentiated resource package from the external device.

With reference to the fifth aspect and the foregoing possible implementations, in another possible implementation, the obtaining unit is specifically configured to: call a second API, where the second API is configured to request the differentiated resource package from the external device; and receive the differentiated resource package from the external device.

With reference to the fifth aspect and the foregoing possible implementations, in another possible implementation, the target device is a server; the querying unit is further configured to query whether the external device has a dynamic resource loading capability; the obtaining unit is further configured to obtain hardware version information and software version information of the external device if the querying unit determines, through querying, that the external device has the dynamic resource loading capability; the determining unit is further configured to determine, based on the hardware version information and the software version information that are obtained by the obtaining unit, whether the terminal device has a compatibility capability to load the differentiated resource package, and whether the terminal device needs to load the differentiated resource package: and the obtaining unit is specifically configured to obtain the differentiated resource package from the server based on the hardware version information and the software version information if the determining unit determines that the terminal device has the compatibility capability to load the differentiated resource package and needs to load the differentiated resource package.

With reference to the fifth aspect and the foregoing possible implementations, in another possible implementation, a display unit is further configured to display prompt information if the external device has no dynamic resource loading capability, or the terminal device has no compatibility capability to load the differentiated resource package, or the terminal device determines that the terminal device does not need to load the differentiated resource package.

With reference to the fifth aspect and the foregoing possible implementations, in another possible implementation, the obtaining unit is specifically configured to: call a third API, where the third API is configured to request the hardware version information and the software version information from the external device, and receive the hardware version information and the software version information from the external device.

With reference to the fifth aspect and the foregoing possible implementations, in another possible implementation, the obtaining unit is specifically configured to: call a fourth API, where the fourth API is configured to: upload the hardware version information and the software version information to the server, and request the server to return the differentiated resource package; and receive the differentiated resource package from the server.

With reference to the fifth aspect and the foregoing possible implementations, in another possible implementation, the configuration unit is specifically configured to: call a fifth API, where the fifth API is configured to read a first script file; load the first script file to complete preprocessing before loading the differentiated resource package; call a sixth API, where the sixth API is configured to read a second script file; and load the second script file to load the adapted code and the presentation resource that are corresponding to the differentiated service, to complete configuration for the external device.

A sixth aspect of the embodiments of this application provides a target device, including: a storage unit, configured to store a differentiated resource package of an external device; and a sending unit, configured to send the differentiated resource package of the external device to a terminal device, where the differentiated resource package includes a differentiated service and adapted code and a presentation resource that are corresponding to the differentiated service, the adapted code and the presentation resource are used by the terminal device to configure the differentiated service for the external device, and the differentiated service is a specific service supported by the external device.

With reference to the sixth aspect, in a possible implementation, the target device is the external device; the target device may further include a receiving unit, configured to receive a first request message from the terminal device, where the first request message is used to request version information of the differentiated resource package from the external device; and the sending unit is further configured to send the version information of the differentiated resource package to the terminal device.

With reference to the sixth aspect and the foregoing possible implementation, in another possible implementation, the receiving unit is further configured to receive a second request message from the terminal device, where the second request message is used to request the differentiated resource package from the external device.

With reference to the sixth aspect and the foregoing possible implementations, in another possible implementation, the target device is a server; the receiving unit is further configured to receive hardware version information and software version information of the external device and a third request message from the terminal device, where the third request message is used to request the server to return the differentiated resource package; and the sending unit is specifically configured to send the differentiated resource package to the terminal device based on the hardware version information and the software version information.

A seventh aspect of the embodiments of this application provides a computer readable storage medium, including a computer software instruction, where when the computer software instruction runs on a terminal device, the terminal device is caused to perform the method for performing configuration for an external device according to any one of the first aspect or the possible implementations of the first aspect.

An eighth aspect of the embodiments of this application provides a computer readable storage medium, including a computer software instruction, where when the computer software instruction runs on a target device, the target device is caused to perform the method for performing configuration for an external device according to any one of the second aspect or the possible implementations of the second aspect.

### BRIEF DESCRIPTION OF DRAWINGS

FIG. 1 is a simplified schematic diagram of a system architecture to which the embodiments of this application are applied according to an embodiment of this application:

FIG. 2 is a simplified schematic diagram of another system architecture to which the embodiments of this application are applied according to an embodiment of this application;

FIG. 3 is a schematic composition diagram of a mobile phone according to an embodiment of this application;

FIG. 4 is a schematic composition diagram of a target device according to an embodiment of this application;

FIG. 5 is a flowchart of a method for performing configuration for an external device according to an embodiment of this application;

FIG. 6A and FIG. 6B are a flowchart of another method for performing configuration for an external device according to an embodiment of this application:

FIG. 7 is a schematic diagram of a scenario of performing configuration for an external device according to an embodiment of this application;

FIG. 8A and FIG. 8B are a flowchart of another method for performing configuration for an external device according to an embodiment of this application:

FIG. 9 is a schematic diagram of another scenario of performing configuration for an external device according to an embodiment of this application:

FIG. 10 is a schematic composition diagram of a terminal device according to an embodiment of this application; and

FIG. 11 is a schematic composition diagram of another target device according to an embodiment of this application.

### DESCRIPTION OF EMBODIMENTS

To resolve a problem that extremely high resource overheads of a terminal device and relatively high management and development costs are caused to perform different configurations for different types of external devices, embodiments of this application provide a method for performing configuration for an external device, and a device. When detecting that a terminal device is successfully connected to an external device, the terminal device obtains a differentiated resource package of the external device from a target device in which the differentiated resource package of the external device is preconfigured, where the differentiated resource package includes a differentiated service and adapted code and a presentation resource that are corresponding to the differentiated service; and configures the differentiated service for the external device based on the obtained adapted code and presentation resource that are corresponding to the differentiated service. The differentiated resource package of the external device is preconfigured on the target device rather than the terminal device, and when detecting that the terminal device is successfully connected to the external device, the terminal device obtains the differentiated resource package of the external device from the target device, to complete configuration for the external device based on the obtained differentiated resource package of the external device. Therefore, resource overheads of the terminal device and management and development costs are reduced while different configurations are performed for different types of external devices.

Implementations of the embodiments of this application are described below in detail with reference to the accompanying drawings.

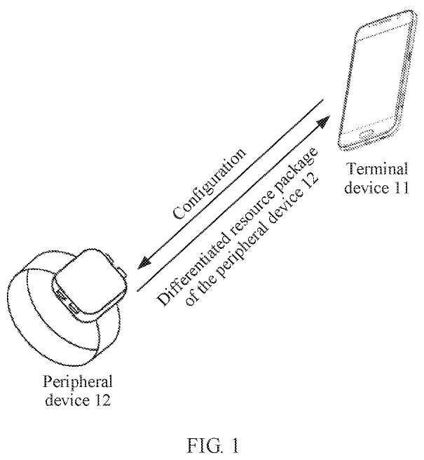

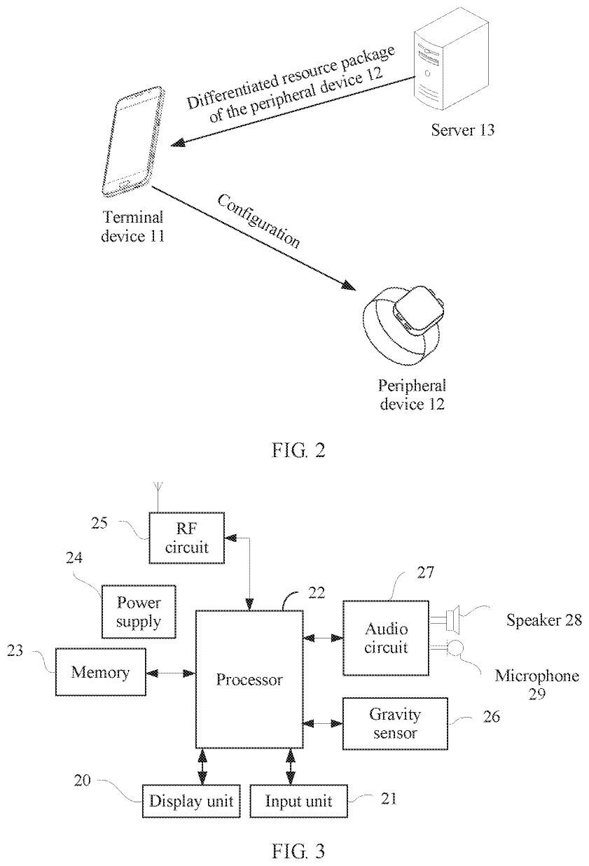

FIG. 1 and FIG. 2 are simplified schematic diagrams of system architectures to which the embodiments of this application are applicable.

As shown in FIG. 1, in a first application scenario of the embodiments of this application, the system architecture may include a terminal device 11 and at least one external device 12.

The terminal device 11 and the external device 12 may be connected in a wired manner or a wireless manner. When the terminal device 11 and the external device 12 are connected in a wireless manner, the terminal device 11 and the external device 12 may be connected by using any one of wireless short-range communications technologies such as Bluetooth (Bluetooth, BT), Wireless Fidelity (Wireless Fidelity, Wi-Fi). Near Field Communication (Near Field Communication. NFC), and infrared (Infrared). A manner in which the terminal device 11 and the external device 12 are connected is not specifically limited herein in this embodiment of this application.

The terminal device 11 is a device that can perform configuration for the external device 12. For example, the terminal device 11 is a wireless terminal that can provide various available network connection capabilities such as BT, Wi-Fi, NFC, and infrared. The wireless terminal may be a device that provides a user with voice and/or data connectivity, a handheld device with a wireless connection function, or another processing device connected to a wireless modem. The wireless terminal may communicate with one or more core networks by using a radio access network (Radio Access Network, RAN). The wireless terminal may be a mobile terminal such as a mobile phone (also referred to as a “cellular” phone) or a computer with a mobile terminal, or may be a portable, pocket-sized, handheld, computer built-in, or in-vehicle mobile apparatus that exchanges voice and/or data with the radio access network. For example, the wireless terminal may be a device such as a mobile phone, a personal communications service (Personal Communications Service, PCS) phone, a cordless phone, a Session Initiation Protocol (Session Initiation Protocol, SIP) phone, a wireless local loop (Wireless Local Loop. WLL) station, or a personal digital assistant (Personal Digital Assistant, PDA). The wireless terminal may also be referred to as a user agent (User Agent), a user device (User Device), or user equipment (User Equipment, UE). For example, in this embodiment of this application, the terminal device 11 is shown as a mobile phone in both FIG. 1 and FIG. 2.

The external device 12 is a hardware device that can be connected to the terminal device 11. The external device 12 can provide a user with a plurality of service functions. For example, the external device 12 may be a wearable device, a game handle, a wireless headset, a wireless acoustic system, or a smart home device. The wearable device may be a device that can provide various available network connection capabilities such as BT, Wi-Fi, NFC, and infrared. The wearable device includes but is not limited to various smart wearable devices such as a smartwatch, a smart band, a smart wristband, smart glasses, a smart necklace, a smart ring, a smart earing, and a smartphone. In addition, various sensors such as an accelerometer, a gyroscope, a magnetometer, a light sensor, and a Global Positioning System (Global Positioning System. GPS) and input/output (Input/Output, I/O) components such as a microphone and a speaker may be built in the wearable device. The wearable device may effectively detect an action (for example, running or walking) of a user, vital sign data (for example, a heart rate or blood pressure) of the user, and a current place of the user (namely, a current position of the user) by using the various sensors, to provide the user with a plurality of service functions. For example, in this embodiment of this application, the external device 12 is shown as a smartwatch in both FIG. 1 and FIG. 2.

As shown in FIG. 2, in a second application scenario of the embodiments of this application, the system architecture may further include a server 13. The server 13 may be an over the air (Over The Air, OTA) server.

In this embodiment of this application, in the application scenario shown in FIG. 1, only a basic service resource package is configured in the terminal device 11. In addition, for each external device in the at least one external device 12, a differentiated resource package of the external device is preconfigured in the external device (the external device is a target device). When configuration needs to be performed for the external device, the terminal device 11 may obtain the differentiated resource package of the external device from the external device, to implement configuration for the external device.

In this embodiment of this application, in the application scenario shown in FIG. 2, only a basic service resource package is configured in the terminal device 11. In addition, for each external device in the at least one external device 12, a differentiated resource package of the external device is preconfigured in the server 13 (the server 13 is a target device). When configuration needs to be performed for an external device in the at least one external device 12, the terminal device 11 may obtain a differentiated resource package of the external device from the server 13, to implement configuration for the external device.

It should be noted that in this embodiment of this application, the basic service resource package is a resource package of a basic service, and a differentiated resource package of an external device is a resource package of a differentiated service supported by the external device. The basic service resource package includes a basic service and adapted code and a presentation resource that are corresponding to the basic service. The differentiated resource package includes a differentiated service and adapted code and a presentation resource that are corresponding to the differentiated service. The basic service is a service that needs to be supported by all external devices, for example, a device upgrade service or a Bluetooth connection monitoring service. The differentiated service is a specific service supported by an external device, for example, a Bluetooth leash service supported by a child watch, or a maximum oxygen consumption amount detection service supported by a running watch.

In this embodiment of this application, an example in which the terminal device is a mobile phone is used for description. Components of the mobile phone are specifically described below with reference to FIG. 3.

As shown in FIG. 3, the mobile phone may include components such as a display unit 20, an input unit 21, a processor 22, a memory 23, a power supply 24, a radio frequency (Radio Frequency, RF) circuit 25, a gravity sensor 26, an audio circuit 27, a speaker 28, and a microphone 29. These components may be connected by using a bus, or may be directly connected. A person skilled in the art may understand that a structure of the mobile phone shown in FIG. 3 constitutes no limitation on the mobile phone, and the mobile phone may include more components than those shown in FIG. 3, or combine some components, or have different component arrangements.

The display unit 20 is operably connected to the processor 22, and is configured to receive and display a processing result returned by the processor 22. For example, the display unit 20 may be configured to display an image captured by using a camera, and various menus of the mobile phone. A graphical user interface (Graphical User Interface, GUI) is usually configured in the display unit 20, and the GUI is configured to provide an easy-to-use interface between a user and an operating system running on the mobile phone.

The input unit 21 may be a single-point or multipoint input unit. The input unit 21 is operably connected to the processor 22, and is configured to receive an input operation of the user. The input unit 21 may be a touchpad or a touchscreen that is placed above or in front of the display unit 20. The touchpad or the touchscreen may collect a touch operation performed by the user on or near the touchpad or the touchscreen (for example, an operation performed by the user on or near the touchscreen by using any proper object or accessory such as a finger or a stylus), and drive a corresponding connection apparatus based on a preset program. For example, the touchpad or the touchscreen may be implemented based on a sensing technology such as capacitance sensing, resistance sensing, surface acoustic wave sensing, pressure sensing, or light sensing. The touchpad or the touchscreen may be integrated with the display unit 20, or may be an independent component.

The processor 22 is a control center of the mobile phone, connects all parts of the entire mobile phone by using various interfaces and lines, and performs various functions of the mobile phone and data processing by running or executing a software program and/or a module that are/is stored in the memory 23 and by invoking data stored in the memory 23, to perform overall monitoring on the mobile phone. During specific implementation, in an embodiment, the processor 22 may include one or more processing units, and an application processor and a modem processor may be integrated into the processor 22. The application processor mainly processes an operating system, a user interface, an application, and the like, and the modem processor mainly processes wireless communication. It may be understood that the modem processor may alternatively be not integrated into the processor 22.

The memory 23 may be configured to store the data, the software program, and the module, and may be a volatile memory (Volatile Memory) such as a random access memory (Random Access Memory, RAM); a nonvolatile memory (Nonvolatile Memory) such as a read-only memory (Read-Only Memory, ROM), a flash memory (Flash Memory), a hard disk (Hard Disk Drive, HDD), or a solid-state drive (Solid-State Drive, SSD); or a combination of the foregoing types of memories. Alternatively, the memory 23 may be a removable storage medium such as a secure digital (Secure Digital, SD) memory card. Specifically, the processor 23 may store program code, and the program code is used to enable the processor 22 to perform, by executing the program code, the method for performing configuration for an external device that is provided in the embodiments of this application. In this embodiment of this application, the memory 23 may prestore a basic service resource package.

The power supply 24 may be a battery, and is logically connected to the processor 22 by using a power supply management system, to implement functions such as charging management, discharging management, and power consumption management by using the power supply management system.

The RF circuit 25 may be configured to: receive or send information, or receive or send a signal in a call process, and in particular, send received information to the processor 22 for processing, and send a signal generated by the processor 22. The RF circuit usually includes but is not limited to an antenna, at least one amplifier, a transceiver, a coupler, a low noise amplifier (Low Noise Amplifier, LNA), a duplexer, and the like. In addition, the RF circuit 25 may further communicate with a network and another device through wireless communication.

The gravity sensor (Gravity Sensor) 26 may detect acceleration values of the mobile phone in all directions (generally, three axes), may detect a gravity value and direction in a static mode, and may be used for a mobile phone gesture identification application (for example, switching between landscape and portrait screens, a related game, or magnetometer gesture calibration), a vibration identification-related function (for example, a pedometer or a stroke), and the like. It should be noted that the mobile phone may further include other sensors such as a pressure sensor, an optical sensor, a gyroscope, a barometer, a hygrometer, a thermometer, and an infrared sensor. Details are not described herein.

The audio circuit 27, the speaker 28, and the microphone 29 may provide an audio interface between the user and the mobile phone. The audio circuit 27 may transmit, to the speaker 28, an electrical signal converted from received audio data, and the speaker 28 converts the electrical signal into a sound signal for output. In addition, the microphone 29 converts a collected sound signal into an electrical signal, and the audio circuit 27 converts the electrical signal into audio data after receiving the electrical signal, and then outputs the audio data to the RF circuit 25 to send the audio data to, for example, another mobile phone, or outputs the audio data to the processor 22 for further processing.

In addition, an operating system runs above the foregoing components. An application such as an APP configured to perform configuration for an external device may be installed and run on the operating system. In addition, although not shown, the mobile phone may further include components such as a Wi-Fi module, a Bluetooth module, and a camera. The Wi-Fi module may be a module that includes a Wi-Fi chip and a Wi-Fi chip driver, and the Wi-Fi chip is capable of running a wireless Internet standard protocol. The Wi-Fi module may be configured to be connected to the external device in the embodiments of this application. The Bluetooth module is a printed circuit board assembly (Printed Circuit Board Assembly, PCBA) into which a Bluetooth function is integrated, and is used for short-range wireless communication. The Bluetooth module may also be configured to be connected to the external device in the embodiments of this application.

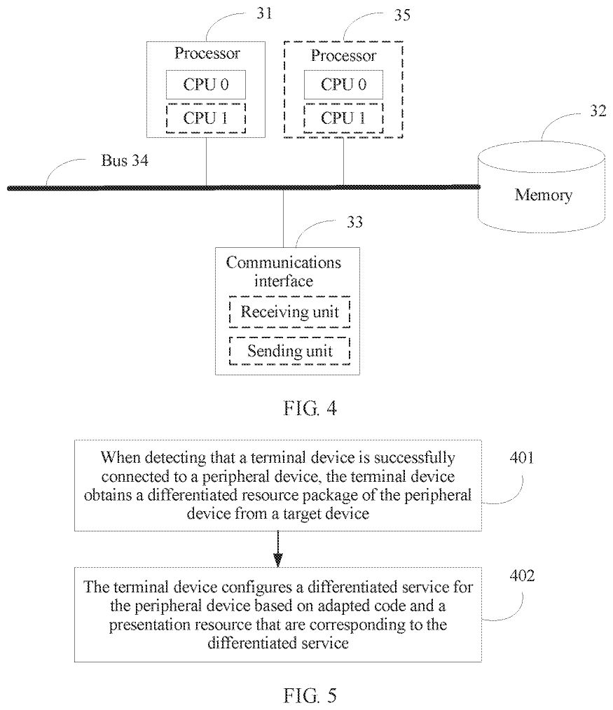

FIG. 4 is a schematic composition diagram of a target device according to an embodiment of this application. The target device may be an external device, or may be a server. As shown in FIG. 4, the target device may include at least one processor 31, a memory 32, a communications interface 33, and a bus 34.

The components of the target device are specifically described below with reference to FIG. 4.

The processor 31 is a control center of the target device, and may be one processor or may be a collective name of a plurality of processing elements. For example, the processor 31 may be a central processing unit (Central Processing Unit, CPU), or may be an application-specific integrated circuit (Application-Specific Integrated Circuit. ASIC), or one or more integrated circuits configured to implement the embodiments of this application, for example, one or more microprocessors (Digital Signal Processor, DSP) or one or more field programmable gate arrays (Field Programmable Gate Array, FPGA).

The processor 31 may perform various functions of the target device by running or executing a software program stored in the memory 32 and by invoking data stored in the memory 32.

During specific implementation, in an embodiment, the processor 31 may include one or more CPUs, for example, a CPU 0 and a CPU 1 that are shown in FIG. 4.

During specific implementation, in an embodiment, the target device may include a plurality of processors, for example, the processor 31 and a processor 35 that are shown in FIG. 4. Each of the processors may be a single-core (single-CPU) processor, or may be a multi-core (multi-CPU) processor. The processor herein may be one or more devices, circuits, and/or processing cores configured to process data (for example, a computer program instruction).

The memory 32 may be a read-only memory (Read-Only Memory, ROM) or another type of static storage device capable of storing static information and instructions, or a random access memory (Random Access Memory, RAM) or another type of dynamic storage device capable of storing information and instructions; or may be an electrically erasable programmable read only memory (Electrically Erasable Programmable Read Only Memory, EEPROM), a compact disc read-only memory (Compact Disc Read-Only Memory, CD-ROM) or another compact disc storage, an optical disc storage (including a compressed optical disc, a laser disc, an optical disc, a digital universal optical disc, a Blu-ray optical disc, and the like), a magnetic disk storage medium or another magnetic storage device, or any other medium capable of carrying or storing expected program code in a form of an instruction or a data structure and capable of being accessed by a computer. However, the memory 32 is not limited thereto. The memory 32 may exist independently, and be connected to the processor 31 by using the bus 34. Alternatively, the memory 32 may be integrated with the processor 31.

The memory 32 is configured to store a software program for executing the solutions in this application, and the processor 31 controls the execution. In this embodiment of this application, in the application scenario shown in FIG. 1, the memory 32 is further configured to store a differentiated resource package of the target device.

The communications interface 33 is configured to communicate with another device or a communications network by using any apparatus like a transceiver. For example, the communications interface 33 is an Ethernet interface, a radio access network (Radio Access Network, RAN) interface, or a wireless local area network (Wireless Local Area Network, WLAN) interface. The communications interface 33 may include a receiving unit for implementing a receiving function, and a sending unit for implementing a sending function.

The bus 34 may be an industry standard architecture (Industry Standard Architecture, ISA) bus, a peripheral component interconnect (Peripheral Component Interconnect. PCI) bus, an extended industry standard architecture (Extended Industry Standard Architecture, EISA) bus, or the like. The bus may fall into an address bus, a data bus, a control bus, or the like. For ease of indication, the bus is indicated by using only one bold line in FIG. 4. However, it does not indicate that there is only one bus or only one type of bus.

Further, optionally, when the target device is an external device, the target device may further include components such as a display screen, a power supply, and a wearing apparatus (for example, a wristband of a smartwatch) used by a user to wear the external device.

The structure of the device shown in FIG. 4 constitutes no limitation on the external device, and the external device may include more or fewer components than those shown in FIG. 4, or combine some components, or have different component arrangements.

FIG. 5 is a flowchart of a method for performing configuration for an external device according to an embodiment of this application. As shown in FIG. 5, the method may include the following steps.

401. When detecting that a terminal device is successfully connected to an external device, the terminal device obtains a differentiated resource package of the external device from a target device.

The differentiated resource package of the external device is preconfigured on the target device, the differentiated resource package includes a differentiated service and adapted code and a presentation resource that are corresponding to the differentiated service, and the differentiated service is a specific service supported by the external device.

For example, the target device may be the external device or a server deployed in the cloud. For example, when the target device is the external device, the differentiated resource package of the external device is preconfigured in the external device. When detecting that the terminal device is successfully connected to the external device, the terminal device may obtain the differentiated resource package of the external device from the external device. For another example, when the target device is the server deployed in the cloud, differentiated resource packages of a plurality of different types of external devices are preconfigured in the server. When detecting that the terminal device is successfully connected to an external device, the terminal device may obtain a corresponding differentiated resource package, in other words, obtain a differentiated resource package of the external device, from the server.

402. The terminal device configures a differentiated service for the external device based on adapted code and a presentation resource that are corresponding to the differentiated service.

After obtaining the differentiated resource package of the external device connected to the terminal device, the terminal device may configure the differentiated service for the external device based on the adapted code and the presentation resource that are included in the obtained differentiated resource package and that are corresponding to the differentiated service. For example, the terminal device adds a new service function to the external device based on the obtained differentiated resource package, or upgrades an existing service function of the external device based on the obtained differentiated resource package.

In the method for performing configuration for an external device that is provided in this embodiment of this application, when detecting that the terminal device is successfully connected to the external device, the terminal device obtains the differentiated resource package of the external device from the target device in which the differentiated resource package of the external device is preconfigured, and configures the differentiated service for the external device based on the adapted code and the presentation resource that are included in the obtained differentiated resource package and that are corresponding to the differentiated service. The differentiated resource package of the external device is preconfigured on the target device rather than the terminal device, and when detecting that the terminal device is successfully connected to the external device, the terminal device obtains the differentiated resource package of the external device from the target device, to complete configuration for the external device based on the obtained differentiated resource package of the external device. Therefore, resource overheads of the terminal device and management and development costs are reduced while different configurations are performed for different types of external devices.

It should be noted that to enable a person skilled in the art to implement configuration performed by the terminal device for the external device by using the method for performing configuration for an external device that is provided in this embodiment of this application, this embodiment of this application herein provides an API configured to perform configuration for the external device and an API description. Details are shown in Table 1. The method for performing configuration for an external device that is provided in this embodiment of this application is specifically described below with reference to the accompanying drawings and Table 1.

TABLE 1

| | | Function |
|---|---|---|
| Function name | Function description | channel |
| getDeviceVersionInfo | Obtain version information of the | Terminal |
| | differentiated resource package of | device- |
| | the external device | external |
| | | device |
| loadDeviceModuleFile | Start file transfer of the external | Terminal |
| | device: The terminal device sends | device- |
| | a request message to the external | external |
| | device to request the external | device |
| | device to report the differentiated | |
| | resource package, and the external | |
| | device uploads the differentiated | |
| | resource package to the terminal | |
| | device after receiving the request | |
| requireUpdate | Upload hardware version information | Terminal |
| | and software version information of | device- |
| | the external device, and request the | cloud |
| | server to return the corresponding | |
| | differentiated resource package | |
| beforeInstall | Preprocessing is required before the | Intra-APP |
| | differentiated resource package is | |
| | loaded: Read a first script file, | |
| | and load the first script file to | |
| | complete the preprocessing | |
| install | Load the differentiated resource | Intra-APP |
| | package: Read a second script file, | |
| | and load the second script file to | |
| | complete loading of the | |
| | differentiated resource package | |
| beforeStart | Preprocessing is required before the | Intra-APP |
| | adapted code is run: Read a | |
| | corresponding script file, and load | |
| | the corresponding script file to | |
| | complete the preprocessing | |
| start | Run the adapted code: Read a | Intra-APP |
| | corresponding script file, and load | |
| | the corresponding script file to | |
| | run the adapted code | |
| beforeStop | Preprocessing is required before | Intra-APP |
| | the adapted code is stopped: Read a | |
| | corresponding script file, and load | |
| | the corresponding script file to | |
| | complete the preprocessing | |
| stop | Stop the adapted code: Read a | Intra-APP |
| | corresponding script file, and load | |
| | the corresponding script file to | |
| | stop the adapted code | |
| beforeUninstall | Preprocessing is required before | Intra-APP |
| | the adapted code is offloaded: Read | |
| | a corresponding script file, and | |
| | load the corresponding script file | |
| | to complete the preprocessing | |
| uninstall | Offload the adapted code: Read a | Intra-APP |
| | corresponding script file, and load | |
| | the corresponding script file to | |
| | offload the adapted code | |
| BLEChannelListener | Listen to BLE code stream | Terminal |
| | transmission | device- |
| | | external |
| | | device |
| BLEChannelSender | Send a BLE code stream | Terminal |
| | | device- |
| | | external |
| | | device |
| BLEFileListener | Listen to BLE file transfer | Terminal |
| | | device- |
| | | external |
| | | device |
| BLEFileSender | Send a BLE file | Terminal |
| | | device- |
| | | external |
| | | device |
| BRChannelListener | Listen to BR code stream | Terminal |
| | transmission | device- |
| | | external |
| | | device |
| BRChannelSender | Send a BR code stream | Terminal |
| | | device- |
| | | external |
| | | device |
| BLEFileListener | Listen to BR file transfer | Terminal |
| | | device- |
| | | external |
| | | device |
| BRFileSender | Send a BR file | Terminal |
| | | device- |
| | | external |
| | | device |
| AWChannelListener | Listen to Android wearable code | Terminal |
| | stream transmission | device- |
| | | external |
| | | device |
| AWChannelSender | Send an Android wearable code | Terminal |
| | stream | device- |
| | | external |
| | | device |
| AWFileListener | Listen to Android wearable file | Terminal |
| | transfer | device- |
| | | external |
| | | device |
| AWFileSender | Send an Android wearable file | Terminal |
| | | device- |
| | | external |
| | | device |
| parentActivityInfo | Obtain parent activity information | Intra-APP |
| initModule | Initialize a service module | Intra-APP |
| startModule | Start the service module | Intra-APP |
| stopModule | Stop the service module | Intra-APP |
| hideModule | Hide the service module | Intra-APP |
| releascModule | Release the service module | Intra-APP |

In Table 1, the function channel “terminal device-external device” is a channel between the terminal device and the external device, the function channel “terminal device-cloud” is a channel between the terminal device and the server, and the function channel “intra-APP” is a call interface between modules inside the terminal device.

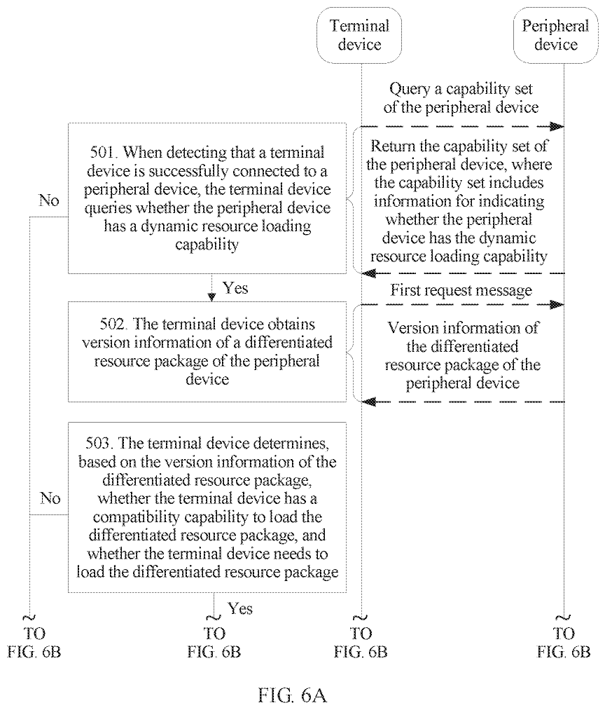

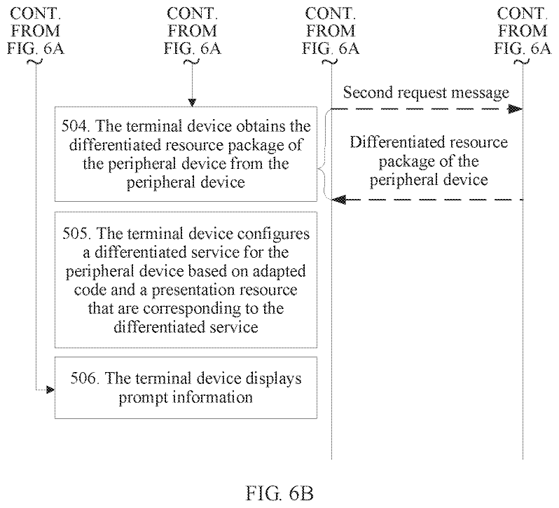

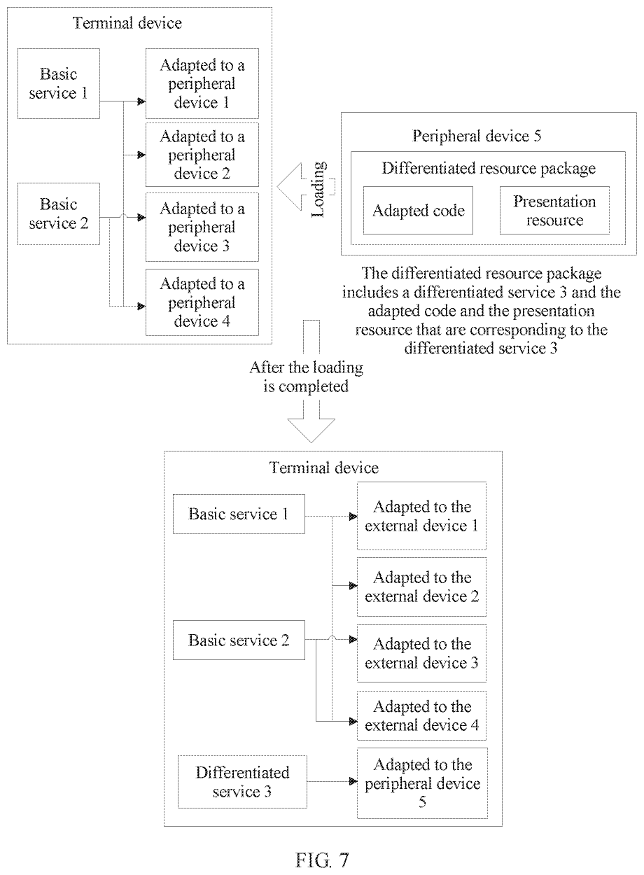

FIG. 6A and FIG. 6B are a flowchart of another method for performing configuration for an external device according to an embodiment of this application. The application scenario that is shown in FIG. 1 and in which a differentiated resource package of an external device is preconfigured in the external device is used as an example in this embodiment to specifically describe the method for performing configuration for an external device. In addition, as shown in FIG. 7, it is assumed that resource packages of a basic service 1 and a basic service 2 are preconfigured in a terminal device, the basic service 1 is adapted to an external device 1, an external device 2, and an external device 4, and the basic service 2 is adapted to an external device 3 and the external device 4; and it is assumed that an external device 5 needs to access the terminal device, a differentiated resource package of the external device 5 is preconfigured in the external device 5, and the differentiated resource package includes a differentiated service 3 and adapted code and a presentation resource that are corresponding to the differentiated service 3. As shown in FIG. 6A and FIG. 6B, the method may include the following steps.

501. When detecting that a terminal device is successfully connected to an external device, the terminal device queries whether the external device has a dynamic resource loading capability.

For example, it is assumed that the terminal device is a mobile phone, the external device 5 that needs to access the terminal device is a smartwatch, and the smartwatch is to be connected to the mobile phone by using a Bluetooth technology. When a user wants the smartwatch to be connected to the mobile phone, the user can enable a Bluetooth function of the smartwatch and set this device to be visible to other devices, and then enable a Bluetooth function of the mobile phone. After detecting that the Bluetooth function is enabled, the mobile phone may perform searching and display a search result list. When the search result list includes an identifier of the smartwatch, the user may select the identifier of the smartwatch from the search result list. After detecting the selection operation of the user, the mobile phone sends a pairing request message to the smartwatch. After receiving the pairing request message, the smartwatch may display a prompt box and a confirm button, to prompt the user to determine whether to confirm the connection to the mobile phone. After the user performs a trigger operation on the confirm button, the mobile phone may send a pairing response message to the smartwatch, to notify the mobile phone of confirmation of the connection. In this way, the mobile phone is successfully connected to the smartwatch.

When detecting that the terminal device is successfully connected to the external device, the terminal device may query whether the external device connected to the terminal device has the dynamic resource loading capability. For example, when the terminal device detects that the terminal device is successfully connected to the external device 5, the terminal device may query a capability set of the external device 5, so that the external device 5 returns the capability set of the external device 5 to the terminal device. The capability set includes information for indicating whether the external device 5 has the dynamic resource loading capability. After receiving the capability set of the external device 5 that is returned by the external device 5, the terminal device may determine, based on the returned capability set, whether the external device 5 has the dynamic resource loading capability. If the external device 5 has the dynamic resource loading capability, the following step 502 may be performed. If the external device 5 has no dynamic resource loading capability, the following step 506 may be performed.

502. The terminal device obtains version information of a differentiated resource package of the external device.

After the terminal device determines that the external device has the dynamic resource loading capability, the terminal device may obtain the version information of the differentiated resource package of the external device. For example, the terminal device may call a first API, and the first API is configured to request version information of the differentiated resource package of the external device 5 from the external device 5. When the first API is called, the terminal device sends, to the external device 5, a first request message used to request the version information of the differentiated resource package of the external device 5 from the external device 5. The external device 5 may receive the first request message from the terminal device, and return the version information of the preconfigured differentiated resource package to the terminal device, so that the terminal device obtains the version information of the differentiated resource package of the external device 5.

For example, it is assumed that the terminal device is a mobile phone, and the external device 5 is a smartwatch. Referring to Table 1, the mobile phone may call the function: getDeviceVersionInfo. When getDeviceVersionInfo is called, the mobile phone sends a request message to the smartwatch, to request the smartwatch to report version information of a preconfigured differentiated resource package. When receiving the request message, the smartwatch may report the version information of the differentiated resource package of the smartwatch to the mobile phone.

503. The terminal device determines, based on the version information of the differentiated resource package, whether the terminal device has a compatibility capability to load the differentiated resource package, and whether the terminal device needs to load the differentiated resource package.

After receiving the version information of the differentiated resource package of the external device, the terminal device may determine, based on the received version information, whether the terminal device has the compatibility capability to load the differentiated resource package, and whether the terminal device needs to load the differentiated resource package. If the terminal device has the compatibility capability to load the differentiated resource package and needs to load the differentiated resource package, the following step 504 may be performed. If the terminal device has no compatibility capability to load the differentiated resource package or does not need to load the differentiated resource package, the following step 506 may be performed.

For example, the terminal device may determine whether a version number to which the version information of the differentiated resource package belongs is the same as a version number to which version information of a target APP (the target APP is an APP that is in the terminal device and that is configured to perform configuration for the external device) belongs, to determine whether the terminal device has the compatibility capability to load the differentiated resource package, and when determining that the terminal device has the compatibility capability to load the differentiated resource package, the terminal device may determine whether the version information of the differentiated resource package is the same as the version information of the target APP, to determine whether the terminal device needs to load the differentiated resource package.

For example, it is assumed that the version information that is of the differentiated resource package of the external device 5 and that is obtained in step 502 is 2.5, and version information of a target APP that is in the terminal device and that is configured to perform configuration for the external device 5 is 1.8. It can be learned that the version information of the differentiated resource package belongs to a version number 2, and the version information of the target APP belongs to a version number 1, and therefore the terminal device can determine that the terminal device has no compatibility capability to load the differentiated resource package of the external device 5. In this case, step 506 may be directly performed. For another example, it is assumed that the version information that is of the differentiated resource package of the external device 5 and that is obtained in step 502 is 2.5, and version information of a target APP that is in the terminal device and that is configured to perform configuration for the external device 5 is 2.1. It can be learned that the version information of the differentiated resource package belongs to a version number 2, and the version information of the target APP also belongs to a version number 2, and therefore the terminal device can determine that the terminal device has the compatibility capability to load the differentiated resource package of the external device 5. In addition, the version information of the differentiated resource package is different from the version information of the target APP, and therefore the terminal device can determine that the terminal device needs to load the differentiated resource package. In this case, step 504 may be performed.

504. The terminal device obtains the differentiated resource package of the external device from the external device.

For example, the terminal device may call a second API, and the second API is configured to request the differentiated resource package of the external device 5 from the external device 5. When the second API is called, the terminal device sends, to the external device 5, a second request message used to request the differentiated resource package from the external device. The external device 5 may receive the second request message from the terminal device, and send the differentiated resource package of the external device 5 to the terminal device, so that the terminal device obtains the differentiated resource package of the external device 5.

For example, it is assumed that the terminal device is a mobile phone, and the external device 5 is a smartwatch. Referring to Table 1, the mobile phone may call the function: loadDeviceModuleFile. When loadDeviceModuleFile is called, the mobile phone sends a request message to the smartwatch, to request the smartwatch to report a preconfigured differentiated resource package of the smartwatch. When receiving the request message, the smartwatch may report the differentiated resource package of the smartwatch to the mobile phone. The differentiated resource package includes the differentiated service 3 and the adapted code and the presentation resource that are corresponding to the differentiated service 3.

505. The terminal device configures a differentiated service for the external device based on adapted code and a presentation resource that are corresponding to the differentiated service.

After the terminal device receives the differentiated resource package of the external device, the terminal device may first decompress the received differentiated resource package, and then configure the differentiated service for the external device based on the adapted code and the presentation resource that are obtained through decompression, that are included in the differentiated resource package, and that are corresponding to the differentiated service.

For example, the terminal device may first obtain built-in summary information from the differentiated resource package through parsing. The built-in summary information may include constraint information such as a preprocessing script and a storage path (the storage path is a packaging path of the presentation resource that is included in the differentiated resource package and that is corresponding to the differentiated service, and may be customized). Then, the terminal device may call a fifth API, and the fifth API is configured to read a first script file. After the fifth API is called, the terminal device may load the read first script file to complete preprocessing before loading the differentiated resource package. For example, the preprocessing may include: clearing an old resource package, starting a loading module, and running the preprocessing script included in the built-in summary information. After completing the preprocessing, the terminal device may call a sixth API, and the sixth API is configured to read a second script file. After the sixth API is called, the terminal device may load the read second script file to load the adapted code and the presentation resource that are corresponding to the differentiated service, to complete configuration for the external device. The presentation resource may include a picture resource, a video resource, a voice resource, and the like.

For example, it is assumed that the terminal device is a mobile phone, and the external device 5 is a smartwatch. Referring to Table 1, the mobile phone may call the function: beforeInstall. When beforeInstall is called, the mobile phone reads a first script file. After reading the first script file, the mobile phone loads the first script file to complete preprocessing before loading a differentiated resource package. After completing the preprocessing, the mobile phone calls the function: install. When install is called, the mobile phone reads a second script file. After reading the second script file, the mobile phone loads the second script file to load adapted code and a presentation resource that are corresponding to a differentiated service, to complete configuration for the external device.

Further, as shown in Table 1, this embodiment of this application further provides a function for performing preprocessing before the adapted code is run: beforeStart, a function for running the adapted code: start, a function for performing preprocessing before the adapted code is stopped: beforeStop, a function for stopping the adapted code: stop, a function for performing preprocessing before the adapted code is offloaded: beforeUninstall, and a function for offloading the adapted code: uninstall. A corresponding function may be called to complete a corresponding function. In addition, after the mobile phone completes configuration for the external device, the mobile phone may implement data transmission between the mobile phone and the external device by calling different functions for different external devices. For example, assuming that the smartwatch is a Bluetooth low energy (Bluetooth Low Energy, BLE) device, the terminal device may call the function: BLEChannelListener, to listen to code stream transmission: call the function: BLEChannelSender, to send a code stream: call the function: BLEFileListener, to listen to file transfer; and call the function: BLEFileSender, to send a file. For another example, assuming that the smartphone is a conventional Bluetooth transmission rate (Bluetooth Rate, BR) device, the terminal device may call the function: BRChannelListener, to listen to code stream transmission; call the function: BRChannelSender, to send a code stream: call the function: BLEFileListener, to listen to file transfer; and call the function: BRFileSender, to send a file. For still another example, assuming that the smartphone is an Android wearable (Android Wearable) device, the terminal device may call the function: AWChannelListener, to listen to code stream transmission; call the function: AWChannelSender, to send a code stream; call the function: AWFileListener, to listen to file transfer; and call the function: AWFileSender, to send a file. As shown in Table 1, after configuration is completed, a corresponding function may be called to display the differentiated service 3. For example, the function: parentActivityInfo is called to obtain parent activity information when the differentiated service 3 is displayed, and the function: hideModule is called to hide a service module of the differentiated service 3. Certainly, corresponding functions may be further called to complete initialization, starting, stopping, releasing, and the like of the service module of the differentiated service 3.

506. The terminal device displays prompt information.

The terminal device displays the prompt information if the external device has no dynamic resource loading capability, or the terminal device has no compatibility capability to load the differentiated resource package, or the terminal device determines that the terminal device does not need to load the differentiated resource package. For example, the terminal device may display prompt information used to prompt the user to upgrade a version of the target APP of the terminal device, or may display prompt information used to give the user a prompt that the external device does not have a specific function.

It should be noted that in this embodiment of this application, an example in which one external device accesses the terminal device is used to describe the method for performing configuration for an external device. A process of performing configuration for another external device that accesses the terminal device is similar to the foregoing process. Details are not described herein in this embodiment of this application.

In the method for performing configuration for an external device that is provided in this embodiment of this application, when detecting that the terminal device is successfully connected to the external device, the terminal device obtains the differentiated resource package of the external device from the target device in which the differentiated resource package of the external device is preconfigured, and configures the differentiated service for the external device based on the adapted code and the presentation resource that are included in the obtained differentiated resource package and that are corresponding to the differentiated service. The differentiated resource package of the external device is preconfigured on the target device rather than the terminal device, and when detecting that the terminal device is successfully connected to the external device, the terminal device obtains the differentiated resource package of the external device from the target device, to complete configuration for the external device based on the obtained differentiated resource package of the external device. Therefore, while different configurations are performed for different types of external devices, resource overheads of the terminal device are reduced, and management and development costs are reduced by completely decoupling different services of different external devices from the terminal device.

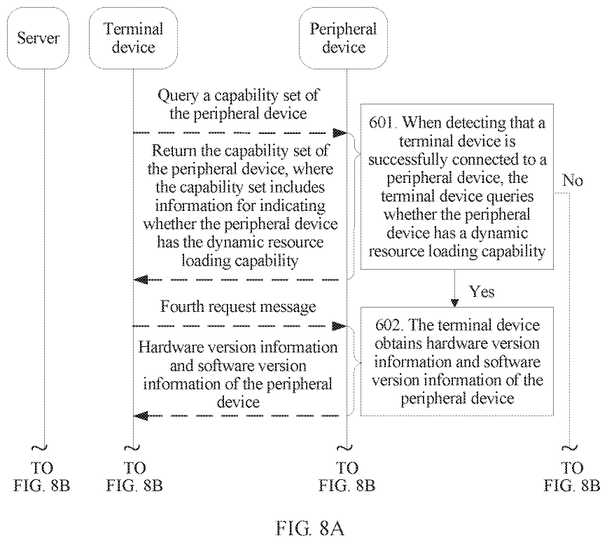

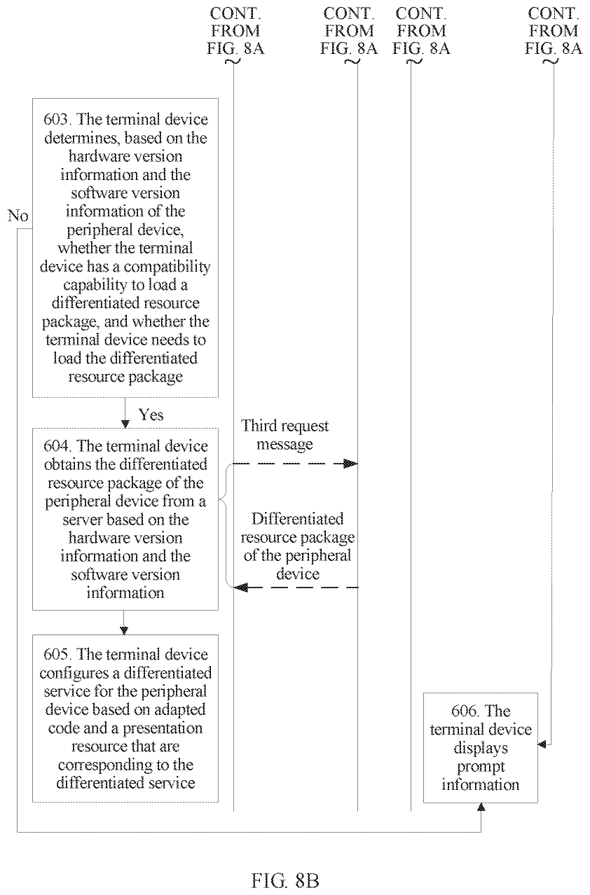

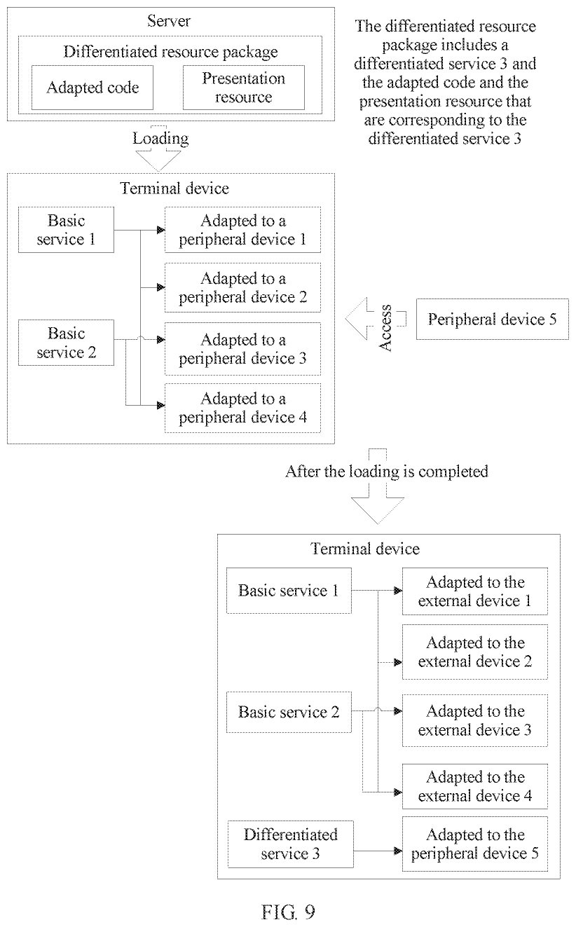

FIG. 8A and FIG. 8B are a flowchart of another method for performing configuration for an external device according to an embodiment of this application. The application scenario that is shown in FIG. 2 and in which a differentiated resource package of an external device is preconfigured in a server is used as an example in this embodiment to specifically describe the method for performing configuration for an external device. In addition, as shown in FIG. 9, it is assumed that resource packages of a basic service 1 and a basic service 2 are preconfigured in a terminal device, the basic service 1 is adapted to an external device 1, an external device 2, and an external device 4, and the basic service 2 is adapted to an external device 3 and the external device 4; and it is assumed that an external device 5 needs to access the terminal device, a differentiated resource package of the external device 5 is preconfigured in a server, and the differentiated resource package includes a differentiated service 3 and adapted code and a presentation resource that are corresponding to the differentiated service 3. As shown in FIG. 8A and FIG. 8B, the method may include the following steps.

601. When detecting that a terminal device is successfully connected to an external device, the terminal device queries whether the external device has a dynamic resource loading capability.

When detecting that the terminal device is successfully connected to the external device 5, the terminal device may query whether the external device 5 connected to the terminal device has the dynamic resource loading capability. If the external device 5 has the dynamic resource loading capability, the following step 602 may be performed. If the external device 5 has no dynamic resource loading capability, the following step 605 may be performed.

602. The terminal device obtains hardware version information and software version information of the external device.

After the terminal device determines that the external device has the dynamic resource loading capability, the terminal device may obtain the hardware version information and the software version information of the external device. The hardware version information may include at least one of the following: a hardware version number, a device type, an international mobile equipment identity (International Mobile Equipment Identity, IMEI) number, a Media Access Control (Media Access Control, MAC) address, and the like. For example, the terminal device may call a third API, and the third API is configured to request the hardware version information and the software version information of the external device from the external device. When the third API is called, the terminal device sends, to the external device 5, a fourth request message used to request hardware version information and software version information of the external device 5 from the external device 5. The external device 5 may receive the fourth request message from the terminal device, and return the hardware version information and the software version information of the external device 5 to the terminal device, so that the terminal device obtains the hardware version information and the software version information of the external device 5.

For example, it is assumed that the terminal device is a mobile phone, and the external device 5 is a smartwatch. The mobile phone may call a corresponding function, and when the function is called, the mobile phone sends a request message to the smartwatch, to request the smartwatch to report hardware version information and software version information of the smartwatch. When receiving the request message, the smartwatch may report the hardware version information and the software version information of the smartwatch to the mobile phone.

603. The terminal device determines, based on the hardware version information and the software version information of the external device, whether the terminal device has a compatibility capability to load a differentiated resource package, and whether the terminal device needs to load the differentiated resource package.

After receiving the hardware version information and the software version information of the external device, the terminal device may determine, based on the hardware version information and the software version information, whether the terminal device has the compatibility capability to load the differentiated resource package, and whether the terminal device needs to load the differentiated resource package. If the terminal device has the compatibility capability to load the differentiated resource package and needs to load the differentiated resource package, the following step 604 may be performed. If the terminal device has no compatibility capability to load the differentiated resource package or does not need to load the differentiated resource package, the following step 606 may be performed.

604. The terminal device obtains the differentiated resource package of the external device from a server based on the hardware version information and the software version information.

After determining that the terminal device has the compatibility capability to load the differentiated resource package and needs to load the differentiated resource package, the terminal device may obtain the differentiated resource package of the external device from the server based on the received hardware version information and software version information of the external device.

For example, the terminal device may call a fourth API, and the fourth API is configured to: upload the hardware version information and the software version information of the external device 5 to the server, and request the server to return the differentiated resource package. When the fourth API is called, the terminal device uploads the hardware version information and the software version information of the external device 5 to the server, and sends, to the server, a third request message used to request the server to return the differentiated resource package. After receiving the hardware version information and the software version information of the external device 5 and the third request message, the server may obtain the differentiated resource package of the external device 5 from prestored differentiated resource packages of a plurality of external devices based on the hardware version information and the software version information of the external device 5, and send the obtained differentiated resource package of the external device 5 to the terminal device, so that the terminal device obtains the differentiated resource package of the external device 5.

For example, it is assumed that the terminal device is a mobile phone, and the external device 5 is a smartwatch. Referring to Table 1, the mobile phone may call the function: requireUpdate. When requireUpdate is called, the mobile phone uploads hardware version information and software version information of the smartwatch to the server, and sends a request message to the server, to request the server to return a differentiated resource package of the smartwatch. When receiving the hardware version information, the software version information, and the request message, the server may obtain the differentiated resource package of the smartwatch based on the hardware version information and the software version information, and send the differentiated resource package of the smartwatch to the mobile phone. The differentiated resource package includes the differentiated service 3 and the adapted code and the presentation resource that are corresponding to the differentiated service 3. [0142] 605. The terminal device configures a differentiated service for the external device based on adapted code and a presentation resource that are corresponding to the differentiated service.

606. The terminal device displays prompt information.

If the external device has no dynamic resource loading capability, the terminal device displays the prompt information.

It should be noted that for detailed descriptions of step 601 to step 606 in this embodiment of this application, refer to detailed descriptions of corresponding steps in step 501 to step 506 in another embodiment of this application. Details are not described herein again in this embodiment of this application. In addition, in this embodiment of this application, an example in which one external device accesses the terminal device is used to describe the method for performing configuration for an external device. A process of performing configuration for another external device that accesses the terminal device is similar to the foregoing process. Details are not described herein in this embodiment of this application.

In the method for performing configuration for an external device that is provided in this embodiment of this application, when detecting that the terminal device is successfully connected to the external device, the terminal device obtains the differentiated resource package of the external device from the target device in which the differentiated resource package of the external device is preconfigured, and configures the differentiated service for the external device based on the adapted code and the presentation resource that are included in the obtained differentiated resource package and that are corresponding to the differentiated service. The differentiated resource package of the external device is preconfigured on the target device rather than the terminal device, and when detecting that the terminal device is successfully connected to the external device, the terminal device obtains the differentiated resource package of the external device from the target device, to complete configuration for the external device based on the obtained differentiated resource package of the external device. Therefore, while different configurations are performed for different types of external devices, resource overheads of the terminal device are reduced, and management and development costs are reduced by completely decoupling different services of different external devices from the terminal device.

To facilitate understanding by a person skilled in the art, examples are used herein in the embodiments of this application to describe the method for performing configuration for an external device that is provided in this application.

Example 1: It is assumed that an external device is a child watch, and a terminal device is a mobile phone. A differentiated resource package of a Bluetooth leash service is preconfigured in the child watch, and the differentiated resource package includes the Bluetooth leash service and adapted code and a presentation resource that are corresponding to the Bluetooth leash service. After the child watch is successfully connected to the mobile phone, the mobile phone may call a function: loadDeviceModuleFile when determining that the child watch has a dynamic resource loading capability, and the mobile phone has a compatibility capability to load the differentiated resource package and needs to load the differentiated resource package. The child watch receives a request message used to request the child watch to report the differentiated resource package of the Bluetooth leash service. In this case, the child watch may report the differentiated resource package of the Bluetooth leash service to the mobile phone. After receiving the differentiated resource package of the Bluetooth leash service, the mobile phone may configure the Bluetooth leash service for the child watch based on the adapted code and the presentation resource that are included in the differentiated resource package of the Bluetooth leash service. In this way, the child watch can trace a movement track of a child.

Example 2: It is assumed that an external device is a running watch, and a terminal device is a mobile phone. A differentiated resource package of an oxygen consumption amount detection service is preconfigured in the running watch, and the differentiated resource package includes the oxygen consumption amount detection service and adapted code and a presentation resource that are corresponding to the oxygen consumption amount detection service. After the running watch is successfully connected to the mobile phone, the mobile phone may call a function: loadDeviceModuleFile when determining that the running watch has a dynamic resource loading capability, and the mobile phone has a compatibility capability to load the differentiated resource package and needs to load the differentiated resource package. The running watch receives a request message used to request the running watch to report the differentiated resource package of the oxygen consumption amount detection service. In this case, the running watch may report the differentiated resource package of the oxygen consumption amount detection service to the mobile phone. After receiving the differentiated resource package of the oxygen consumption amount detection service, the mobile phone may configure the oxygen consumption amount detection service for the running watch based on the adapted code and the presentation resource that are included in the differentiated resource package of the oxygen consumption amount detection service. In this way, the running watch can monitor an oxygen consumption amount of a user.

Example 3: It is assumed that an external device is a smartwatch, and a terminal device is a mobile phone. The smartwatch supports a heart rate monitoring service, a differentiated resource package of the heart rate monitoring service is stored in a server in the cloud, and the differentiated resource package includes the heart rate monitoring service and adapted code and a presentation resource that are corresponding to the heart rate monitoring service. After the smartwatch is successfully connected to the mobile phone, the mobile phone may call a function: requireUpdate when determining that the smartwatch has a dynamic resource loading capability, and the mobile phone has a compatibility capability to load the differentiated resource package and needs to load the differentiated resource package. The smartwatch receives hardware version information and software version information of the smartwatch and a request message used to request the smartwatch to report the differentiated resource package of the heart rate monitoring service. In this case, the smartwatch may obtain, based on the hardware version information and the software version information, the differentiated resource package of the smartwatch, namely, the differentiated resource package of the heart rate monitoring service, and report the differentiated resource package to the mobile phone. After receiving the differentiated resource package of the heart rate monitoring service, the mobile phone may configure the heart rate monitoring service for the smartwatch based on the adapted code and the presentation resource that are included in the differentiated resource package of the heart rate monitoring service. In this way, the smartwatch can monitor a heart rate of a user.

The solutions provided in the embodiments of this application are mainly described above from the perspective of interaction between network elements. It may be understood that to implement the foregoing functions, the network elements such as the terminal device and the target device include corresponding hardware structures and/or software modules for performing the functions. A person skilled in the art should be easily aware that the algorithm steps in the examples described with reference to the embodiments disclosed in this specification can be implemented by hardware or a combination of hardware and computer software in this application. Whether the functions are performed by hardware or computer software driving hardware depends on particular applications and design constraint conditions of the technical solutions. A person skilled in the art may use different methods to implement the described functions for each particular application, but it should not be considered that the implementation goes beyond the scope of this application.

In the embodiments of this application, the terminal device may be divided into function modules based on the foregoing method examples. For example, each function module may be obtained through division based on each corresponding function, or two or more functions may be integrated into one processing module. The integrated module may be implemented in a form of hardware, or may be implemented in a form of a software function module. It should be noted that the module division in the embodiments of this application is an example and is merely logical function division, and there may be another division manner during actual implementation.

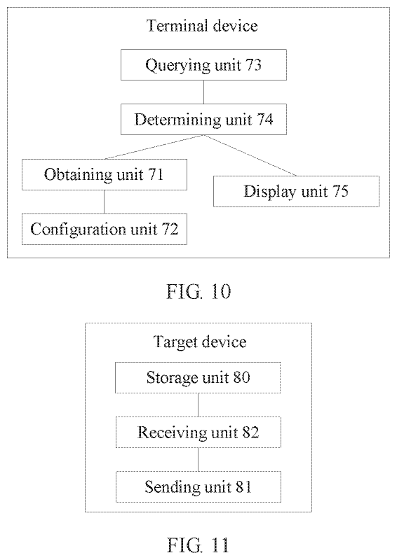

For example, when each function module is obtained through division based on each corresponding function, FIG. 10 is a possible schematic structural diagram of the terminal device in the foregoing embodiments. As shown in FIG. 10, the terminal device may include an obtaining unit 71 and a configuration unit 72.

The obtaining unit 71 is configured to: when it is detected that the terminal device is successfully connected to an external device, obtain a differentiated resource package of the external device from a target device, where the differentiated resource package of the external device is preconfigured on the target device, the differentiated resource package includes a differentiated service and adapted code and a presentation resource that are corresponding to the differentiated service, and the differentiated service is a specific service supported by the external device.

The configuration unit 72 is configured to configure the differentiated service for the external device based on the adapted code and the presentation resource that are obtained by the obtaining unit 71 and that are corresponding to the differentiated service.

In this embodiment of this application, further, the target device is the external device. As shown in FIG. 10, the terminal device may further include a querying unit 73 and a determining unit 74.

The querying unit 73 is configured to query whether the external device has a dynamic resource loading capability.

The obtaining unit 71 is further configured to obtain version information of the differentiated resource package if the querying unit determines, through querying, that the external device has the dynamic resource loading capability.

The determining unit 74 is configured to determine, based on the version information that is of the differentiated resource package and that is obtained by the obtaining unit 71, whether the terminal device has a compatibility capability to load the differentiated resource package, and whether the terminal device needs to load the differentiated resource package.

The obtaining unit 71 is specifically configured to obtain the differentiated resource package from the external device if the determining unit 74 determines that the terminal device has the compatibility capability to load the differentiated resource package and needs to load the differentiated resource package.

In this embodiment of this application, as shown in FIG. 10, the terminal device may further include a display unit 75.

The display unit 75 is configured to display prompt information if the external device has no dynamic resource loading capability, or the terminal device has no compatibility capability to load the differentiated resource package, or the terminal device determines that the terminal device does not need to load the differentiated resource package.

In this embodiment of this application, further, the target device is a server. The querying unit 73 is configured to query whether the external device has a dynamic resource loading capability.

The obtaining unit 71 is further configured to obtain hardware version information and software version information of the external device if the querying unit determines, through querying, that the external device has the dynamic resource loading capability.

The determining unit 74 is configured to determine, based on the hardware version information and the software version information that are obtained by the obtaining unit 71, whether the terminal device has a compatibility capability to load the differentiated resource package, and whether the terminal device needs to load the differentiated resource package.

The obtaining unit 71 is specifically configured to obtain the differentiated resource package from the server based on the hardware version information and the software version information if the determining unit 74 determines that the terminal device has the compatibility capability to load the differentiated resource package and needs to load the differentiated resource package.

In this embodiment of this application, further, the configuration unit 72 is specifically configured to: invoke a fifth API, where the fifth API is configured to read a first script file; load the first script file to complete preprocessing before loading the differentiated resource package: invoke a sixth API, where the sixth API is configured to read a second script file; and load the second script file to load the adapted code and the presentation resource that are corresponding to the differentiated service, to complete configuration for the external device.

It should be noted that all related content of the steps in the foregoing method embodiments may be cited in function descriptions of corresponding function modules. Details are not described herein.

The terminal device provided in this embodiment of this application is configured to perform the foregoing method for performing configuration for an external device, and therefore can achieve a same effect as the foregoing method for performing configuration for an external device.

When each function module is obtained through division based on each corresponding function. FIG. 11 is a possible schematic structural diagram of the target device in the foregoing embodiments. The target device may be a server, or may be an external device. As shown in FIG. 11, the target device may include a storage unit 80 and a sending unit 81.

The storage unit 80 is configured to store a differentiated resource package of an external device.

The sending unit 81 is configured to send the differentiated resource package of the external device to a terminal device, where the differentiated resource package includes a differentiated service and adapted code and a presentation resource that are corresponding to the differentiated service, the adapted code and the presentation resource are used by the terminal device to configure the differentiated service for the external device, and the differentiated service is a specific service supported by the external device.

In this embodiment of this application, further, as shown in FIG. 11, the target device is the external device. The target device may further include a receiving unit 82.

The receiving unit 82 is configured to receive a first request message from the terminal device, where the first request message is used to request version information of the differentiated resource package from the external device.

The sending unit 81 is further configured to send the version information of the differentiated resource package to the terminal device.

In this embodiment of this application, the receiving unit 82 is further configured to receive a second request message from the terminal device, where the second request message is used to request the differentiated resource package from the external device.

In this embodiment of this application, further, the target device is a server. The receiving unit 82 is configured to receive hardware version information and software version information of the external device and a third request message from the terminal device, where the third request message is used to request the server to return the differentiated resource package.

The sending unit 81 is specifically configured to send the differentiated resource package to the terminal device based on the hardware version information and the software version information that are received by the receiving unit 82.

It should be noted that all related content of the steps in the foregoing method embodiments may be cited in function descriptions of corresponding function modules. Details are not described herein.

The target device provided in this embodiment of this application is configured to perform the foregoing method for performing configuration for an external device, and therefore can achieve a same effect as the foregoing method for performing configuration for an external device.

Based on the foregoing descriptions of the implementations, a person skilled in the art may clearly understand that for the purpose of convenient and brief description, division of the foregoing function modules is merely used as an example for illustration. During actual application, the foregoing functions can be allocated to different function modules for implementation based on a requirement. In other words, an inner structure of an apparatus is divided into different function modules to implement all or some of the functions described above.

In the several embodiments provided in this application, it should be understood that the disclosed apparatus and method may be implemented in other manners. For example, the apparatus embodiments described above are merely examples. For example, the module or unit division is merely logical function division and there may be another division manner during actual implementation. For example, a plurality of units or components may be combined or integrated into another apparatus, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may be one or more physical units, in other words, may be located in one place, or may be distributed on a plurality of different places. Some or all of the units may be selected based on an actual requirement to achieve the objectives of the solutions in the embodiments.

In addition, the function units in the embodiments of this application may be integrated into one processing unit, or each of the units may exist alone physically, or two or more units may be integrated into one unit. The integrated unit may be implemented in a form of hardware, or may be implemented in a form of a software function unit.

When the integrated unit is implemented in the form of a software function unit and sold or used as an independent product, the integrated unit may be stored in a readable storage medium. Based on such an understanding, the technical solutions in the embodiments of this application essentially, or the part contributing to the prior art, or all or some of the technical solutions may be implemented in a form of a software product. The software product is stored in a storage medium and includes several instructions for instructing a device (that may be a single-chip microcomputer, a chip, or the like) or a processor (processor) to perform all or some of the steps in the methods described in the embodiments of this application. The storage medium includes any medium that can store program code, such as a USB flash drive, a removable hard disk, a read-only memory (Read-Only Memory, ROM), a random access memory (Random Access Memory, RAM), a magnetic disk, or an optical disc.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

1.-30. (canceled)

31. A system comprising
a first watch, configured to perform a first basic service and a first differentiated service;
a second watch, configured to perform a second basic service and a second differentiated service;
a mobile phone, comprising a basic service resource package associated with the first basic service, and wherein the basic service resource package comprises a third adapted code and a third presentation resource that corresponds to the first basic service and the second basic service, wherein the mobile phone is configured to:
configure the first basic service for the first watch based on the third adapted code and the third presentation resource;
obtain a first differentiated resource package of the first watch, wherein the first differentiated resource package is associated with the first differentiated service of the first watch, and wherein the first differentiated resource package comprises a first adapted code and a first presentation resource that corresponds to the first differentiated service;
configure the first differentiated service for the first watch based on the first adapted code and the first presentation resource;
configure the second basic service for the second watch based on the third adapted code and the third presentation resource;
obtain a second differentiated resource package of the second watch; wherein the second differentiated resource package is associated with the second differentiated service of the second watch, and wherein the second differentiated resource package comprises a second adapted code and a second presentation resource that corresponds to the second differentiated service; and
configure the second differentiated service for the second watch based on the second adapted code and the second presentation resource.

32. The system of claim 31, wherein the mobile phone is configured to obtain the first or second differentiated resource package from a server.

33. The system of claim 31, wherein the mobile phone is configured to obtain the first or second differentiated resource package from the first or second watch.

34. The system of claim 31, wherein at least one of the first basic service and the second basic service comprises at least one of, an upgrade service, or a wireless short-range connection monitoring service.

35. The system of claim 32, wherein the first watch comprises a dynamic resource loading capability, and wherein before obtaining the first differentiated resource package from the server, the mobile phone is further configured to determine, based on hardware version information and software version information of the first watch, that the mobile phone has a compatibility capability to load the first differentiated resource package to the first watch.

36. The system of claim 33, wherein the first watch comprises a dynamic resource loading capability, and wherein before obtaining the first differentiated resource package from the first watch, the mobile phone is further configured to determine, based on version information of the first watch, that the mobile phone has a compatibility capability to load the first differentiated resource package to the first watch.

37. The system of claim 31, wherein the mobile phone is further configured to:
call a first application programming interface (API) to read a first script file;
load the first script file to complete preprocessing before loading a differentiated resource package;
call a second API to read a second script file; and
load the second script file to load an adapted code and a presentation resource that corresponds to the differentiated service to complete the configuration for the first or second watch.

38. A system comprising:
a first external device configured to perform a first basic service and a first differentiated service; and
a second external device configured to perform a second basic service and a second differentiated service;
an electronic device, comprising a basic service resource package associated with the first basic service and the second basic service, and wherein the basic service resource package comprises a third adapted code and a third presentation resource, that correspond to the first basic service and the second basic service, wherein the electronic device is configured to:
configure the first basic service for the first external device based on the third adapted code and the third presentation resource;
obtain a first differentiated resource package of the first external device, wherein the first differentiated resource package is associated with the first differentiated service of the first external device, and wherein the first differentiated resource package comprises a first adapted code and a first presentation resource that corresponds to the first differentiated service;
configure the first differentiated service for the first external device based on the first adapted code and the first presentation resource;
configure the second basic service for the second external device based on the third adapted code and the third presentation resource;
obtain a second differentiated resource package of the second external device, wherein the second differentiated resource package is associated with the second differentiated service of the second external device, and wherein the second differentiated resource package comprises a second adapted code and a second presentation resource that corresponds to the second differentiated service; and
configure the second differentiated service for the second external device based on the second adapted code and the second presentation resource.

39. The system of claim 38, wherein the electronic device is configured to obtain the first or second differentiated resource package from a server.

40. The system of claim 38, wherein the electronic device is configured to obtain the first or second differentiated resource package from the first or second external device.

41. The system of claim 38, wherein at least one of the first basic service and the second basic service comprises at least one of, an upgrade service, or a wireless short-range connection monitoring service.

42. The system of claim 39, wherein the first external device comprises a dynamic resource loading capability, and wherein before obtaining the first differentiated resource package from the server, the electronic device is further configured to determine, based on hardware version information and software version information of the first external device, that the electronic device has a compatibility capability to load the first differentiated resource package to the first external device.

43. The system of claim 40, wherein the first external device comprises a dynamic resource loading capability, and wherein before obtaining the first differentiated resource package from the first external device, the electronic device is further configured to determine, based on version information of the first external device, that the electronic device has a compatibility capability to load the first differentiated resource package to the first external device.

44. The system of claim 38, wherein, the electronic device is further configured to:
call a first application programming interface (API) for reading a first script file;
load the first script file to complete preprocessing before loading a differentiated resource package;
call a second API to read a second script file; and
load the second script file to load an adapted code and a presentation resource that corresponds to the differentiated service to complete the configuration for the first or second external device.

45. An electronic device comprising:
a processors; and
a memory coupled with the processor and configured to store instructions for a basic service resource package associated with a first basic service of a first external device and a second basic service of a second external device, a third adapted code and a third presentation resource that corresponds to the first basic service and the second basic service, that when executed by the processor, cause the electronic device to be configured to:
configure the first basic service for the first external device based on the third adapted code and the third presentation resource;
obtain a first differentiated resource package of the first external device; wherein the first differentiated resource package is associated with a first differentiated service of the first external device, and wherein the first differentiated resource package comprises a first adapted code and a first presentation resource that corresponds to the first differentiated service;
configure the first differentiated service for the first external device based on the first adapted code and the first presentation resource;
configure the second basic service for the second external device based on the third adapted code and the third presentation resource;
obtain a second differentiated resource package of the second external device, wherein the second differentiated resource package is associated with a second differentiated service of the second external device, and wherein the second differentiated resource package comprises a second adapted code and a second presentation resource that corresponds to the second differentiated service; and
configure the second differentiated service for the second external device based on the second adapted code and the second presentation resource.

46. The electronic device of claim 45, wherein at least one of the first basic service and the second basic service comprises an upgrade service or a wireless short-range connection monitoring service.

47. The electronic device of claim 45, wherein the first external device comprises a dynamic resource loading capability, and wherein before obtaining the first differentiated resource package from a server, the programs further cause the electronic device to be configured to determine, based on hardware version information and software version information of the first external device, that the electronic device has a compatibility capability to load the first differentiated resource package it the first external device.

48. The electronic device of claim 45, wherein the first external device comprises a dynamic resource loading capability, and wherein before obtaining the first differentiated resource package from the first external device, the programs further cause the electronic device to be configured to determine, based on version information of the first external device, that the electronic device has a compatibility capability to load the first differentiated resource package to the first external device.

49. The electronic device of claim 45, wherein the programs further cause the electronic device to be configured to:
call a first application programming interface (API) for reading a first script file;
load the first script file to complete preprocessing before loading a differentiated resource package;
call a second API to read a second script file; and
load the second script file to load an adapted code and a presentation resource that corresponds to the differentiated service to complete the configuration for the first or second external device.

50. The electronic device of claim 45, wherein both the first basic service and the second basic service comprise a wireless short-range connection monitoring service.
